(19) United States
(12) Patent Application Publication
(10) Pub. No.: US 2025/0390766 A1
(43) Pub. Date: Dec. 25, 2025

(54) Method and device for constructing a knowledge base for the purpose of making cross-functional use of the application functions of a plurality of software items

(71) Applicant: ORANGE, ISSY LES MOULINEAUX (FR)

(72) Inventors: Tiphaine Marie, Chatillon (FR); Maryline Gidon, Chatillon (FR); Jean Francois Letellier, Chatillon (FR); Alan Glen Boyd, Chatillon (FR)

(21) Appl. No.: 19/102,078

(22) PCT Filed: Aug. 2, 2023
(86) PCT No.: PCT/EP2023/071468

§ 371 Date: Feb. 7, 2025

(30) Foreign Application Priority Data
Aug. 10, 2022 (FR) 2208230

(51) Int. Cl. G06N 5/022; G06F 9/451; G06V 10/70; G06V 30/262

(52) U.S. Cl. CPC G06N 5/022; G06F 9/452; G06V 10/768; G06V 30/262; G06V 2201/02

(57) ABSTRACT

A method for constructing a knowledge base, implemented by a construction device during use of an electronic terminal. The method includes: when a system event on the electronic terminal is detected, a first step of obtaining at least one position datum in relation to a cursor, the cursor being associated with at least one pointing peripheral, and at least one digital image of a snapshot of at least part of the output of at least one screen of the terminal; and a second step of obtaining at least one system datum from the electronic terminal; a third step of obtaining at least one context datum based on analysis of all or part of the digital image; and a step of updating the knowledge base with the at least one position datum, system datum and context datum.

### 1. FIELD OF THE INVENTION

The invention lies in the field of electronic terminals capable of executing a plurality of applications. More particularly, the invention relates to techniques that make it possible for example to execute functions of one or more applications transversely, that is to say without depending on a given application.

### 2. PRIOR ART

Electronic terminals (computers, smartphones, tablets, etc.) may have increasingly large screens, and computational capabilities that allow them to run a large number of computer applications simultaneously.

In this context, each application may offer its own user experience. One drawback is that this may lead to a lack of homogeneity between the user interfaces of the applications executed by the electronic terminal.

Moreover, some applications change regularly in order to offer new functionalities. This is the case for example when applications offer application programming interfaces (APIs) enabling the development of plug-ins/external modules capable of providing new functionalities. One drawback is that user interfaces of applications are becoming increasingly rich/complex, and therefore difficult for the user to understand.

Thus, when a user uses an application for the first time, it is not uncommon for the user to need a longer or shorter amount of time to adapt before being able to use it correctly. There is therefore a need for a simple solution that allows a user and/or a dedicated application to control, with a unified user experience, a plurality of applications executed on an electronic terminal, the solution needing to be independent of the applications to be controlled.

### 3. SUMMARY OF THE INVENTION

The invention aims to improve the prior art and, to this end, proposes a method for constructing a knowledge base, said method being implemented by a construction device during use of an electronic terminal, and characterized in that the method comprises:
when a system event on said electronic terminal is detected,
   a first step of obtaining at least one position datum concerning a cursor, said cursor being associated with at least one pointing peripheral of said electronic terminal, and at least one digital image of a capture of at least a portion of the rendering of at least one screen of said electronic terminal;
   a second step of obtaining at least one system datum from said electronic terminal;
   a third step of obtaining at least one context datum on the basis of analysis of all or part of said digital image;
   a step of updating said knowledge base with said at least one position, system and context datum.

The proposed solution is thus based on a novel and inventive approach consisting in constructing a knowledge base by utilizing not only the system events of an electronic terminal triggered by a user, but also screen capture and image analysis technologies in order to automatically establish a lookup table between each function of each application (computer application) used by the user and the associated system actions (actions executed by the electronic terminal).

One advantage of the proposed solution is that it is simple to implement since all that is necessary, besides the terminal that the user already possesses, is a computing machine (possibly the one already present in the terminal).

Another advantage of the proposed solution is that it allows generic construction of the knowledge base without having to access the APIs of each application executed by the terminal. In other words, because it is not based on the APIs of an application executed by the terminal, the proposed solution makes it possible to create a knowledge base independent (“agnostic”) of this application, with regard to how information related to the use of this application is collected. The proposed solution therefore requires little implementation effort.

Another advantage of the proposed solution is that a computer application configured to use the content of this knowledge base (over the top (OTT) application) may be used to carry out transverse control, for example via one and the same human-machine interface, of the various computer applications present on the electronic terminal. Indeed, when the user requests execution of an action/function on their terminal via the OTT application, for example the action of launching an IP (Internet Protocol) telephony application, said OTT application consults the knowledge base and then retrieves the information needed to execute the action according to the requested action (for example the description). The information may comprise:
the position of the icon of an IP telephony application, that is to say the position of the cursor obtained and saved within the knowledge base during a previous use/execution of the IP telephony application (for example when the user selects/clicks on the icon of the IP telephony application with a mouse connected to the electronic terminal). According to one particular embodiment, the position of the cursor saved within the knowledge base corresponds to the position of the icon when the user releases the press/pressure on a button of the mouse of their electronic terminal. This embodiment makes it possible, when the user moves the icon of the IP telephony application, to update the knowledge base with the new position of the icon. Indeed, an icon is moved on a screen of an electronic terminal for example via a click that is not released, that is to say kept held down, on a button of the mouse of the electronic terminal added to a movement of the cursor to the desired position. Once the position has been reached, the user releases the pressure exerted on the button of the mouse so that the icon moves to the desired position;
a context datum, such as for example the size and the position of the user interface of the telephony application to be executed (execution parameters);
etc.

Once these data have been retrieved, the OTT application may then execute the telephony application, for example by simulating a click on the icon of the IP telephony application. The OTT application may also provide display parameters to the IP telephony application once it has launched.

In other words, the OTT computer application does not have to be application-specific and is able to cooperate with the generic knowledge base, which may contain information related to multiple applications (although, in one particular implementation, it may also contain information related to a single application).

In addition, even if the one or more applications evolve (for example via an update and a version change), or else if the user adds an application on their terminal, the proposed solution continues to work without requiring an update, since it relies on (partial or total) screen extractions and/or system events.

Moreover, the knowledge base is enriched over time by virtue of the user's actions carried out on the applications of the electronic terminal.

It should be noted that the method may, when context data and/or system data are obtained, detect that the application being used by the user corresponds to the OTT application. In this case, the method might not update the knowledge base.

According to one particular embodiment, the OTT application may autonomously and transversely control the functions of the applications of the electronic terminal on the basis of predetermined computer routines (a sequence of computer instructions). A routine may for example comprise detecting a particular event obtained from the electronic terminal such as the detection of an action by a user, the exceedance of a threshold or of a duration, etc.

An electronic terminal is understood to mean any device capable at least of managing a display peripheral and/or a pointing/input peripheral (personal computer, smartphone, electronic tablet, television, on-board computer of a car, connected objects, etc.).

A system event is understood to mean an event generated by an operating system of an electronic terminal. For example, the system event is generated upon receipt of a message or else following an action by a user on a peripheral of the electronic terminal. For example, a system event may be triggered following the execution of a computer command (initiated or not initiated by the user).

A system datum is understood to mean a datum obtained for example from the operating system of the electronic terminal.

According to one particular mode of implementation of the invention, a method as described above is characterized in that said system event is generated by at least one pointing peripheral associated with said electronic terminal.

In this embodiment, the method is triggered when the user interacts and carries out an action (for example a click) on a pointing peripheral associated with the electronic terminal.

A pointing peripheral is understood to mean any input device allowing a user to enter position data (coordinates/spatial data), for example via a cursor, and/or action data, for example via a click, on an electronic terminal. A pointing peripheral is for example a touchpad, a mouse, a trackball, a trackpoint or else a joystick.

According to one particular mode of implementation of the invention, a method as described above is characterized in that the capture concerns an active application window.

In this embodiment, the method captures a portion of the screen that corresponds to the active application window displayed on the screen. An application window is a window linked to the execution of an application by the terminal. An active application window is an application window that is currently being used by the user, that is to say that holds the focus. This embodiment is applicable in particular if the terminal allows multi-windowing (that is to say is able to display multiple application windows simultaneously). If the terminal is able to display only a single application window at a time (the case for a smartphone terminal for example), the application window corresponds to the active application window. The capture is then carried out on the entire screen of the terminal.

It should be noted that the terminal may be associated with or comprise one or more display peripherals.

According to one particular mode of implementation of the invention, a method as described above is characterized in that said at least one context datum is obtained via an optical character recognition technique and/or a computer vision technique.

The knowledge base may thereby be enriched with two types of information: that extracted from text and that extracted from image elements. This covers most, or even in some cases all, of the useful data contained in the image.

According to one particular mode of implementation of the invention, a method as described above is characterized in that the updating step is conditional on the value of a confidence score associated with said at least one context datum.

The quality of the information collected and stored in the knowledge base is thereby improved.

According to one particular mode of implementation of the invention, a method as described above is characterized in that said at least one system datum comprises at least one computer command able to be executed by the operating system of said electronic terminal.

The information collected and stored in the knowledge base thereby comprises system commands capable of being replayed by an OTT computer application. For example, when the user wishes to program the shutdown of their Windows 10 ™ computer via the OTT application, said OTT application obtains the associated command from the knowledge base (shutdown-s-f-t xxx, where “xxx” corresponds to the desired delay). Of course, this assumes that this action has already been carried out beforehand by the user via another application and added to the knowledge base.

One advantage of this embodiment is that it is possible to control an application and/or trigger a computer function even when this is not accessible via the human-machine interface rendered by the electronic terminal. Indeed, the execution of the command makes it possible to execute the function requested by the user without having to simulate a mouse click on the graphical button or on a menu associated with the requested function.

The system datum may also comprise the name of the active application (that is to say the application currently being used by the user). The name of the application is for example obtained from the operating system of the electronic terminal via a system command or else via a specific API such as the JavaScript Node.js “.getActiveWindow ( )” command of the “npm” package manager. This is generally the name of the executable file of the application, that is to say the file comprising the computer code allowing the electronic terminal to execute the application. It should be noted that the name of the executable may be compared to elements in a list comprising the commercial names of the applications. It is thus possible, by virtue of the name of the executable, to obtain the name of the application whose graphical interface is rendered by a screen of the electronic terminal.

According to one particular mode of implementation of the invention, a method as described above is characterized in that said context datum belongs to the group comprising at least:
a description;
a graphical window size;
a position within said screen;
a text;
an image.

The proposed solution is thus able to take into account the great diversity of the data obtained as a result of the analysis of the digital image. It is effective even if the user manipulates a large number of applications. In concrete terms, the context datum may comprise the version of the application, the name of the application/of the computer function, the description of the function, the position within the image of a graphical element and/or of a description associated with the function, and more generally any information associated with the application and/or the computer function used by the user on the electronic terminal. The context datum may also comprise a keyboard shortcut associated with the function used and/or an image symbolizing the function.

The context datum may also comprise the nature/type of the graphical window displayed by a computer application on a screen of the electronic terminal. Indeed, it is possible, for example, using the computer vision technique, to distinguish a videoconferencing window from an instant messaging window that are displayed by one and the same application (for example Microsoft Teams). The nature/type of the window may thus correspond to the main function rendered by the graphical window (writing an email, videoconferencing, instant messaging, document database, etc.).

This list of types of context datum is not exhaustive.

The invention also relates to a device for constructing a knowledge base implemented during use of an electronic terminal, and characterized in that the device comprises:
a first module for obtaining at least one position datum concerning a cursor, said cursor being associated with said at least one pointing peripheral of said electronic terminal, and at least one digital image of a capture of at least a portion of the rendering of at least one screen of said electronic terminal;
a second module for obtaining at least one system datum from said electronic terminal;
a third module for obtaining at least one context datum on the basis of analysis of all or part of said digital image;
a module for updating said knowledge base with said at least one position, system and context datum.

The term “module” may correspond to a software component as well as to a hardware component or to a set of hardware and software components, a software component itself corresponding to one or more computer programs or subroutines or, more generally, to any element of a program capable of implementing a function or a set of functions as described for the modules in question. In the same way, a hardware component corresponds to any element of a hardware assembly capable of implementing a function or a set of functions for the module in question (integrated circuit, chip card, memory card, etc.).

The invention also relates to a server, a gateway or a terminal, characterized in that it comprises a construction device as described above.

The invention also relates to a computer program comprising instructions for implementing the above method according to any one of the particular embodiments described above when said program is executed by a processor. The method may be implemented in various ways, in particular in hard-wired form or in software form. This program may use any programming language and be in the form of source code, object code or intermediate code between source code and object code, such as in a partially compiled form, or in any other desirable form.

The invention also targets a computer-readable recording medium or information medium containing instructions of a computer program as mentioned above. The abovementioned recording media may be any entity or device capable of storing the program. For example, the medium may comprise a storage means, such as a ROM, for example a CD-ROM or a microelectronic circuit ROM, or else a magnetic recording means, for example a hard disk. Moreover, the recording media may correspond to a transmissible medium such as an electrical or optical signal, which may be conveyed via an electrical or optical cable, by radio or by other means. The programs according to the invention may in particular be downloaded from the Internet.

As an alternative, the recording media may correspond to an integrated circuit in which the program is incorporated, the circuit being suitable for executing or for being used in the execution of the method in question.

This construction device and this computer program have features and advantages analogous to those described above in relation to the construction method.

### 4. LIST OF THE FIGURES

Other features and advantages of the invention will become more clearly apparent on reading the following description of particular embodiments, which are given by way of mere illustrative and non-limiting examples, and the appended drawings, in which:

FIG. 1 illustrates an example of an environment for implementing the invention, according to one particular embodiment of the invention,

FIG. 2 illustrates the architecture of a device designed to implement the construction method, according to one particular embodiment of the invention;

FIG. 3 illustrates the main steps of the construction method according to one particular embodiment of the invention.

### 5. DESCRIPTION OF ONE EMBODIMENT OF THE INVENTION

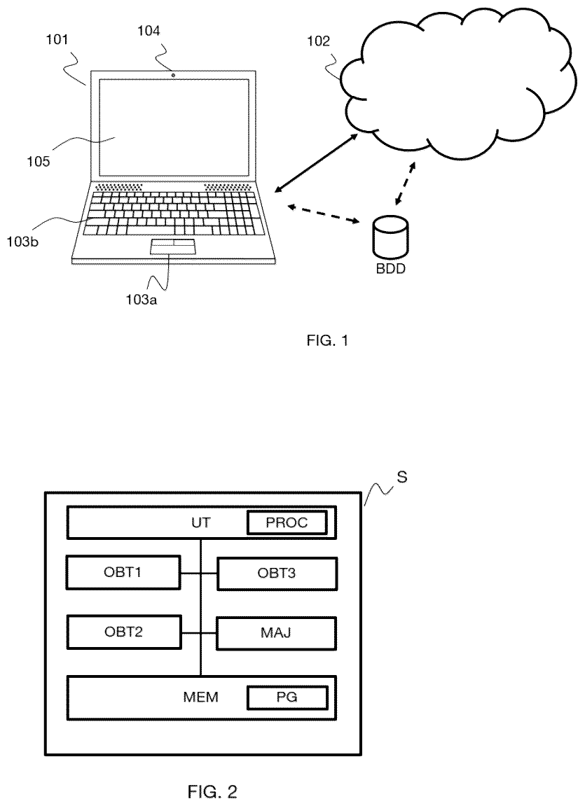

FIG. 1 illustrates an example of an environment for implementing the invention, according to one particular embodiment. The environment shown in FIG. 1 comprises at least one terminal 101 integrating a construction device capable of implementing the construction method according to the present invention.

The method may run at all times and autonomously as soon as the device is activated, or else following a user action.

The terminal 101 is for example a terminal of smartphone, tablet, connected television, connected object, on-board computer of a car, personal computer, server, gateway, etc. type. One or more graphics-rendering/display peripherals (105) may be contained within the terminal 101 or else connected (connected in wired fashion via a VGA, HDMI, USB, etc. cable or else wirelessly via Wi-Fi®, Bluetooth®, etc. technology). These one or more rendering peripherals may be a screen or a video projector.

According to one particular embodiment of the invention, the one or more graphics-rendering peripherals may be connected to the terminal 101 via the network 102. Similarly, one or more input/pointing peripherals (103a, 103b) may be contained within the terminal 101 or else connected (connected in wired fashion via a VGA, HDMI, USB, etc. cable or else wirelessly via Wi-Fi®, Bluetooth®, etc. technology). These one or more pointing peripherals may be a keyboard, a mouse, a touch-sensitive surface, a camera (104), a microphone or else any other peripheral capable of providing data concerning a location of and action on an element displayed by a display peripheral of the terminal 101.

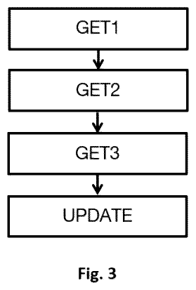

FIG. 2 illustrates a device(S) configured to implement the construction method, according to one particular embodiment of the invention. The device(S) has the conventional architecture of a computer, and comprises in particular a memory MEM, a processing unit UT, equipped for example with a processor PROC, and driven by the computer program PG stored in memory MEM. The computer program PG comprises instructions for implementing the steps of the construction method as described below with reference to FIG. 3 when the program is executed by the processor PROC.

On initialization, the code instructions of the computer program PG are for example loaded into a memory before being executed by the processor PROC. The processor PROC of the processing unit UT in particular implements the steps of the construction method according to any one of the particular embodiments described with reference to FIG. 3, and in accordance with the instructions of the computer program PG.

The device(S) comprises an obtaining module OBT1 capable of obtaining at least one position datum concerning a cursor associated with a pointing/input peripheral. The position datum may be obtained following an action carried out on the pointing peripheral. This action may be a movement (for example a movement symbolizing a cross made using the cursor of the pointing peripheral, the coordinates then possibly corresponding to the coordinates of the point of intersection of the two straight lines forming the cross), a click (the coordinates possibly corresponding to the coordinates of the cursor of the pointing peripheral at the time of the click, that is to say when pressure is exerted or else released on a button of the pointing peripheral), a long press (the coordinates possibly corresponding to the coordinates of the cursor of the pointing peripheral at the time of the long press, for example a press of several seconds), etc.

The device(S) comprises an obtaining module OBT2 capable of obtaining at least one system datum from the operating system of the terminal 101. The system datum may be a command, the name of a computer process executed by the operating system of the terminal 101 or else any information obtained and/or generated by the operating system of the terminal 101.

The device(S) furthermore comprises an obtaining module OBT3 capable of obtaining at least one context datum as the result of analysis of at least one digital image of a capture of at least a portion of the rendering of at least one screen of the terminal 101. The technique used to obtain a context datum may be an optical character recognition and/or computer vision technique.

The device(S) also comprises an update module MAJ capable of feeding and updating a knowledge base, such as a centralized and/or distributed database or else one or more files.

FIG. 3 illustrates the steps of the method for constructing a knowledge base (for example a database) according to one particular embodiment of the invention. Once this knowledge base is sufficiently rich with information, an OTT application may utilize it in order to offer innovative services, such as for example a single interface capable of controlling the computer applications installed on the electronic terminal. The OTT application may also autonomously and transversely control the functions of the applications of the electronic terminal on the basis of predetermined computer routines (a sequence of instructions).

The method is implemented by a construction device. The construction device implementing the method is integrated into, or combined with, the user's terminal 101 (this terminal is for example a desktop or portable personal computer, a digital tablet, a personal digital assistant, a smartphone, a workstation, an on-board computer, etc.). In a second implementation, the construction device implementing the method is integrated into, or combined with, another electronic device that cooperates with the user's terminal. This other device is for example a server, a home gateway, a smartphone, a connected object, etc.

According to another embodiment, the construction device may be located in the network and/or distributed over one or more computing machines such as computers, terminals or servers.

In this particular embodiment, it is assumed that the user's terminal allows multi-windowing, that is to say the simultaneous display of multiple application windows on the screen of the terminal. As already mentioned above, an application window is a window linked to the execution of an application by the terminal.

It is also assumed that the operating system of the terminal makes it possible to retrieve certain system events and to provide them to the construction device that implements the present method, such as the position of a cursor of a pointing peripheral associated with the user's terminal, the name of a computer process or a computer command that has recently been executed by the terminal.

In the first step (GET1), the method obtains a position datum concerning a cursor from a pointing device/peripheral (a touchpad, a mouse, a trackball, a trackpoint, a joystick or else from a camera (via an eye tracking method)).

This position datum may correspond to pixel coordinates or else to a ratio (relative position, for example as a percentage) of the size of the screen and/or of a graphical window when a particular system event is detected. The position datum is obtained for example following an action carried out by a user of the terminal 101 on an input peripheral. This action may be a click carried out via a mouse, the pressing down of a particular key on a keyboard, a selection command uttered by the user, a particular gesture captured by a camera contained in or associated with the terminal 101 (for example the camera 104) or any action allowing interaction with a human-machine interface rendered by the terminal 101 via the screen 105. In this step, the method also obtains an image representative of the content displayed by a display peripheral (105) of the terminal 101. The image is obtained for example from software executed by the terminal 101 capable of capturing the graphical content of the display peripheral 105 of the terminal 101.

As an alternative, the image is obtained from a third-party terminal (for example a camera or a smartphone) positioned so as to capture the content displayed by a display peripheral (105) of the terminal 101. The latter case may involve the third-party terminal transmitting the image to the terminal 101.

As an alternative, the method generates an image representative of the graphical content of the display peripheral 105 of the terminal 101.

According to one particular embodiment of the invention, the obtained image corresponds to a portion of the content rendered by the display peripheral 105, for example the active graphical window (the window that holds the focus).

In the second step (GET2), the method obtains a system datum from the operating system of the terminal 101. This system datum may comprise the name of a process currently being executed and/or a system command able to be interpreted by the operating system of the terminal 101 and capable of triggering an action/event on the terminal 101 (for example the launching or closing of software, the execution of a function, etc.). This system datum may also comprise the name of the active application (application that has the focus) along with execution parameters such as the size of the active graphical window of the application and its position within the screen.

According to one particular embodiment of the invention, the method may obtain the system datum from third-party software and/or a third-party device.

In step (GET3), the method analyzes the image obtained in step GET1. The analysis may comprise optical character recognition applied to the image. Optical character recognition makes it possible to obtain a transcription of the text contained in the image in the form of a character string/sequence.

The analysis may furthermore comprise recognition via a computer vision technique. This technique makes it possible to extract information from graphical elements contained within the image. For example, text recognition, object recognition, recognition of a specific element (image depicting an animal, a vehicle, etc.). These techniques (optical character recognition and computer vision) may be applied to a portion of the image (for example centered on the basis of the position datum obtained in step GET1).

In one particular implementation, each text element (a line for example) or image element recognized by a recognition technique (OCR, computer vision, etc.) is ignored if a confidence score associated with the recognition is less than a particular threshold (configuration parameter). In other words, extracted information is taken into account only if it is associated with a detection confidence score greater than a confidence value.

According to one particular embodiment of the invention, the optical character recognition and/or computer vision is/are carried out by third-party software. The one or more results, for example the transcription of the text (character string/sequence and the associated position of said characters) and/or the recognized graphical elements, are transmitted to the method by the third-party software.

According to one particular embodiment of the invention, the method carries out optical character recognition and/or computer vision on the image.

Once the analysis has been carried out, the method obtains a set of context data as a result.

These data may belong to the group comprising:
a text (for example the description of a given function via a pop-up or a tooltip);
a description (name of the function and/or a keyboard shortcut) associated with a graphical element (button, menu, window);
the size of a graphical element (button, window, menu, text, description, etc.) within the image;
the position of a graphical element within the image;
an image associated with a function of the application (for example an image of a graphical element (button, menu, etc.)) capable of triggering the execution of a function following a user action (click, voice command, press of a key on a keyboard, etc.);
etc.

The description may also comprise the nature/type of the main function rendered by a displayed and/or active graphical window (for example: “writing emails”, “videoconferencing”, “instant messaging” window, etc.).

Of course, the above list of context data is not limiting, and other types of context data may be determined during the analysis of the image.

It should be noted that the position may correspond to pixel coordinates or else to a ratio (relative position, for example as a percentage) of the size of the graphical window that contains the graphical element. The information concerning position and size is formed by an X, Y position (for example with respect to a corner of the rectangular window) and a (height, width) pair. The present invention is not limited to rectangular application windows, but is applicable regardless of shape (round, oval, etc.).

In the step UPDATE, the method updates a knowledge base (BDD) with the position data, the system data and the context data. When the database is sufficiently full (that is to say the learning period has been sufficiently long), it may be used by a third-party application to control the applications present on the terminal 101.

Indeed, this knowledge base may be considered to be a lookup table between each function of each application (computer application) used by the user and the associated system actions (actions executed by the electronic terminal) and the position of these functions in an application window.

Example of an application: A user regularly uses videoconferencing software. The construction method is carried out for example when the user clicks (system event in the sense of the invention) on the icon for hanging up/leaving the videoconference. At the time of the click, the method may obtain:
the position of the cursor of the mouse of the user's computer (position datum in the sense of the invention);
an image of the content displayed by the user's screen, corresponding to the active window of the videoconferencing software;
the position of the window and/or the position of the cursor with respect to the window;
the name of the computing process that has just carried out the action. The name of the process may correspond to the name of the active software/window. It is obtained for example by scrutinizing the use of the processor and/or memory (variation/peak in consumption). It should be noted that the name of the active window may also be obtained in response to the execution of a command transmitted to the operating system of the terminal.

The method then carries out analysis of the image via an optical character recognition and/or computer vision technique. The method may obtain the following context data as a result:
a description of the active graphical window (which may correspond to the name of the application, to a version number, to a document title, etc.);
the size of the active application window (length and width) in pixels;
a description located close to the position of the cursor. In this particular case, the description corresponds to “leave”. It should be noted that the description corresponds to the function invoked by the user when they clicked (that is to say leave the videoconference). The description may also correspond to a keyboard shortcut. In our case, the shortcut may correspond to “ctrl+F4”;
an image/icon located close to the position of the cursor (that is to say associated with the function invoked by the user). In our case, this may be a clickable pictogram symbolizing a cross for leaving the videoconference;
a description indicating the type/nature of the active window. In our case, the description may correspond to “videoconference”.

It should be noted that the obtained data may be ignored if a confidence score associated with the optical character recognition and/or with the computer vision is less than a particular threshold (configuration parameter). In other words, extracted information is taken into account only if it is associated with a detection confidence score greater than a confidence value.

The method then updates or adds all or some of this information to the knowledge base BDD (distributed or non-distributed database). A database record may have a format of the type:

{“function”, “application name”, “X position”, “Y position”}
or else {“function”, “application name”, “X position”,
“Y position”, “keyboard shortcut”};
or else {“function”, “application name”, “X position”,
“Y position”, “type”}.

The X and Y positions may correspond to the relative coordinates (for example as a percentage) of the cursor within the active application window.

In the case described above, the record may correspond to:
{“leave”, “Microsoft Teams”, “left: 0.85”, “top: 0.09”, “videoconference”}

Of course, before adding this record, the method checks that a record of the same type does not exist within the database. This check consists in searching the database for a record having an identical primary key. In our case, the primary key may correspond to:

{“function”, “application name”};
to {“function image/icon”, “application name”};
or else to {“function”, “application name”, “type”}.

If such a record exists, the method compares the obtained data with those present within the record. If the data match, no processing is carried out by the method. Otherwise, the method updates the data in the found record with the data previously obtained from the operating system of the terminal and the analysis of the image.

When the database is sufficiently full, it may be used by a third-party application to control the applications present on the user's computer.

Thus, when the third-party application asks to leave a videoconference (for example following a user request), it retrieves the relevant data (for example the position of the clickable graphical element corresponding to the function “leave”, that is to say the X and Y coordinates) from the knowledge base via for example a search whose primary key is the name of the function and the name of the software. The third-party application (OTT) then replays the click (simulates the user's click) at the previously obtained position (X,Y).

Of course, this assumes that the function invoked by the user via the third-party application (OTT) is displayed on the screen of the terminal 101.

According to one particular embodiment of the invention, the method may also replay the keyboard shortcut corresponding to the function invoked by the user.

According to one particular embodiment of the invention, the method may, in the step of updating the knowledge base, add an identifier associated with the active application window. This identifier is obtained for example by applying a cryptographic function to the obtained image. The cryptographic function may be a hash function allowing a hash of the image to be obtained. This embodiment makes it possible, when the primary key comprises this identifier, to distinguish one and the same function (for example “leave”) that might be present within two different graphical windows of one and the same application.

This identifier may also comprise a datum obtained from the operating system of the terminal 101, such as for example the name and/or the access path (tree of one or more folders/computer files) to the executable of the active application window.

It should be noted that, when the identifier of the window corresponds to a hash, this assumes that the content of the window does not vary.

According to one particular embodiment of the invention, the method may obtain, from the operating system, the system command generated following the user's mouse click. This command may then be contained in the record obtained by the third-party application (OTT). In the case described above, the record may correspond to:
{“function”, “application name”, “X position”, “Y position”, “command”}

The command may then be executed by the operating system of the computer at the request of the third-party application (that is to say of the user).

Thus, if the functionality “leave” is available via a button in the human-machine interface but also via an “option/leave” sub-menu, the system command asking the application to leave the videoconference will be the same (regardless of whether the user clicked on the button or went through the menu/sub-menu). In addition, and in contrast to the solution described above based on replaying a mouse click or a keyboard shortcut, it is not necessary for the function invoked by the third-party application (OTT) to be displayed on the screen of the terminal 101.

1. A method for constructing a knowledge base, said method being implemented by a construction device during use of an electronic terminal, and comprising:
in response to a system event on said electronic terminal being detected,
obtaining at least one position datum concerning a cursor, said cursor being associated with at least one pointing peripheral of said electronic terminal, and at least one digital image of a capture of at least a portion of a rendering of at least one screen of said electronic terminal;
obtaining at least one system datum from said electronic terminal;
obtaining at least one context datum based on an analysis of all or part of said digital image; and
updating said knowledge base with said at least one position datum, system datum and context datum.

2. The method as claimed in claim 1, wherein said system event is generated by at least one pointing peripheral associated with said electronic terminal.

3. The method as claimed in claim 1, wherein the capture concerns an active application window.

4. The method as claimed in claim 1, wherein said at least one context datum is obtained via an optical character recognition technique and/or a computer vision technique.

5. The method as claimed in claim 1, wherein the updating is conditional on a value of a confidence score associated with said at least one context datum.

6. The method as claimed in claim 1, wherein at least one system datum comprises at least one computer command able to be executed by an operating system of said electronic terminal.

7. The method as claimed in claim 1, wherein said context datum belongs to the group consisting of:
a description;
a graphical window size;
a position within said screen;
a text;
an image.

8. A device for constructing a knowledge base implemented during use of an electronic terminal, and wherein the device comprises:
at least one processor; and
at least one non-transitory computer readable medium comprising instructions stored thereon which when executed by the at least one processor configure the device to:
obtain at least one position datum concerning a cursor, said cursor being associated with at least one pointing peripheral of said electronic terminal, and at least one digital image of a capture of at least a portion of a rendering of at least one screen of said electronic terminal;
obtain at least one system datum from said electronic terminal;
obtain at least one context datum based on an analysis of all or part of said digital image; and
update said knowledge base with said at least one position datum, system datum and context datum.

9. A server, a gateway or the electronic terminal, which comprises the device as claimed in claim 8.

10. A non-transitory computer-readable medium comprising a computer program stored thereon comprising instructions for executing method of constructing a knowledge base when the program is executed by a processor of a construction device, wherein the construction method comprises, during use of an electronic terminal:
in response to a system event on said electronic terminal being detected,
obtaining at least one position datum concerning a cursor, said cursor being associated with at least one pointing peripheral of said electronic terminal, and at least one digital image of a capture of at least a portion of a rendering of at least one screen of said electronic terminal;
obtaining at least one system datum from said electronic terminal;
obtaining at least one context datum based on an analysis of all or part of said digital image; and
updating said knowledge base with said at least one position datum, system datum and context datum.
